(19) United States
(12) Patent Application Publication
(10) Pub. No.: US 2014/0342770 A1
(43) Pub. Date: Nov. 20, 2014

(54) METHOD FOR SELECTING AN ANTENNA SET AND WIRELESS COMMUNICATION DEVICE UTILIZING THE SAME

(71) Applicant: Wistron NeWeb Corp., Hsinchu (TW)

(72) Inventors: Shih-Min YANG, Hsinchu (TW); Chia-Hsin WU, Hsinchu (TW); Kuang-Chun LIU, Hsinchu (TW); Fu-Ming KANG, Hsinchu (TW)

(73) Assignee: Wistron NeWeb Corp., Hsinchu (TW)

(21) Appl. No.: 13/954,375

(22) Filed: Jul. 30, 2013

(30) Foreign Application Priority Data
May 16, 2013 (TW) 102209119

(51) Int. Cl. H04B 7/04; H04W 88/06

(52) U.S. Cl. CPC H04B 7/0404; H04W 88/06
USPC 455/552.1

(57) ABSTRACT

Embodiments of a method for selecting an antenna set and a wireless communication device utilizing the same are described. The wireless communication device includes a set of external antenna ports, a set of internal antennas, a communication circuit and a controller. The set of external antenna ports receives a set of first RF signals from a set of external antennas. The set of internal antennas receives a set of second RF signals. The communication circuit, coupled to the set of external antenna ports and the set of internal antennas, determines a first signal quality according to the set of first RF signals, determines a second signal quality according to the set of second RF signals, determines which of the first or second signal quality is higher, and switches to the set of antennas which correspond to the higher signal quality.

### CROSS REFERENCE TO RELATED APPLICATIONS

This application claims priority of Taiwan Patent Applications No. 102209119, filed on May 16, 2013, the entirety of which is incorporated by reference herein.

### BACKGROUND OF THE INVENTION

1. Field of the Invention

The present invention relates to wireless communication, and in particular to a method for selecting an antenna set and a wireless communication device utilizing the same in wireless communication.

2. Description of the Related Art

With the rapid rise in mobile communications, providing an integrated service for voice and data to one or more mobile communication devices such as smartphones and tablet PCs has become a direction for the future development for communication service providers. An Integrated Access Device (IAD) is a communication apparatus which connects to external third generation (3G), fourth generation (4G) or Wireless Fidelity (WiFi) mobile communication networks and provides data and voice services to a plurality of residential or commercial mobile communication devices in a local area network.

In order to receive a stronger signal from the external mobile communication networks, the IAD is equipped with internal and external antennas, and is able to choose one therefrom to communicate with the external mobile communication network.

### BRIEF SUMMARY OF THE INVENTION

A detailed description is given in the following embodiments with reference to the accompanying drawings.

An embodiment of a control method is described, adopted by a wireless communication device, comprising: receiving a set of first Radio Frequency (RF) signals from a set of external antenna ports; determining a first signal quality based on the set of first RF signals; receiving a set of second RF signals from a set of internal antennas; determining a second signal quality based on the set of second RF signals; determining which of the first or second signal quality is the higher signal quality; and switching to the set of antennas corresponding to the higher signal quality.

Another embodiment of a wireless communication device is disclosed, comprising a set of external antenna ports, a set of external antennas, a communication circuit, and a controller. The set of external antenna ports are configured to receive a set of first RF signals from a set of external antennas. The set of external antennas are configured to receive a set of second RF signals from a set of internal antennas. The communication circuit, coupled to the set of external antenna ports and the set of external antennas, is configured to determine a first signal quality based on the set of first RF signals and determine a second signal quality based on the set of second RF signals. The controller, coupled to the communication circuit, is configured to determine which of the first or second signal quality is the higher signal quality, and switch to the set of antennas corresponding to the higher signal quality.

### BRIEF DESCRIPTION OF THE DRAWINGS

The present invention can be more fully understood by reading the subsequent detailed description and examples with references made to the accompanying drawings, wherein:

FIG. 1 is a block diagram of an integrated access device (IAD) 1 according to an embodiment of the invention.

FIG. 2 is a flowchart of a control method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

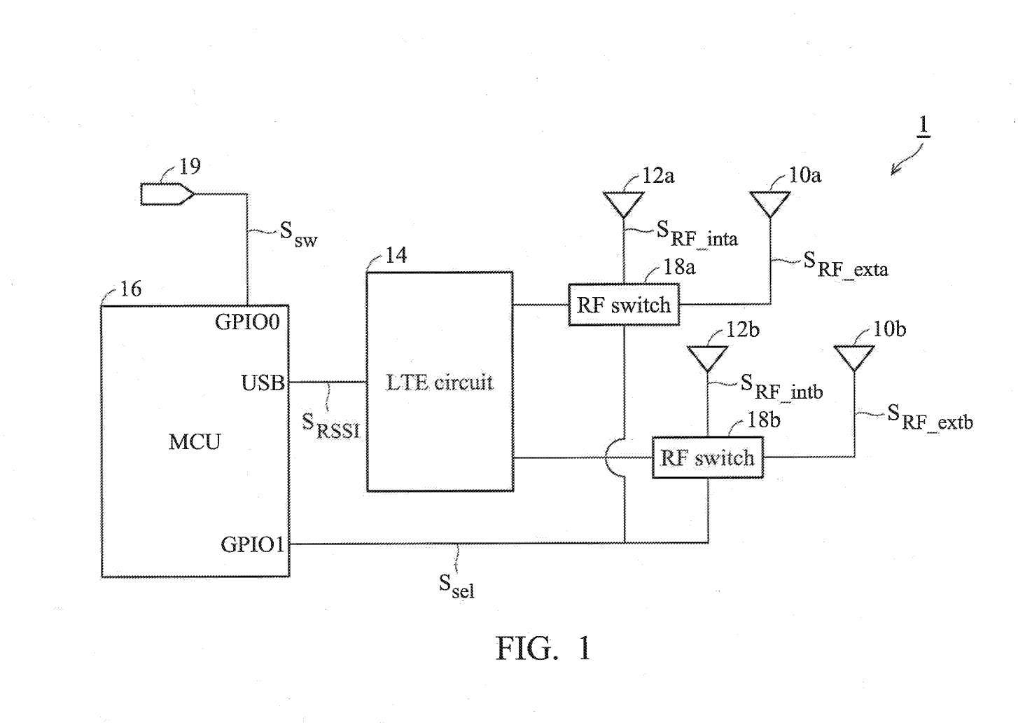

FIG. 1 is a block diagram of an integrated access device (IAD) 1 according to an embodiment of the invention, including a set of external antennas 10a, 10b, a set of internal antennas 12a, 12b, a Long Term Evolution (LTE) circuit 14, a Micro-Controller Unit (MCU) 16, Radio Frequency (RF) switches 18a, 18b, and an external button 19. The IAD 1 is adopted by LTE technology.

The IAD 1 can select one set of antennas, from the set of internal antennas 12a, 12b and the set of external antennas 10a, 10b, to communicate with the service network.

Each of the set of internal antennas and the set of external antennas contains two antennas, which provides antenna diversity or dual mode function. The MCU 16 can select one from the sets of the internal antennas or external antennas based on a Received Signal Strength Indication (RSSI) (signal quality) of the received signal, communicating with the service network.

The RF switches 18a and 18b receive a selection signal Sₛₑₗ from the MCU 16 to select a set of antennas for use. When the RF switches 18a and 18b select the set of external antennas 10a, 10b, the LTE circuit 14 can receive a set of first RF signals S_{RF}_{_{—}}ₑₓₜₐ, S_{RF}_{_{—}}_{extb} only from the set of external antennas 10a, 10b, perform an antenna diversity calculation based on the received set of first RF signals to produce a processed first RF signal (not shown), compute an external RSSI (first signal quality) according to the received set of first RF signals, and pass the external RSSI to the MCU by the signal S_{RSSI}. When the RF switches 18a and 18b select the set of internal antennas 12a, 12b, the LTE circuit 14 can receive a set of second RF signals S_{RF}_{_{—}}ᵢₙₜₐ, S_{RF}_{_{—}}_{intb} only from the set of internal antennas 12a, 12b, compute an internal RSSI (second signal quality) according to the received set of second RF signals, perform an antenna diversity calculation based on the received set of second RF signals to produce a processed second RF signal (not shown), and pass the internal RSSI to the MCU by the signal S_{RSSI}.

Upon the IAD 1 being powered on or disconnected, the set of antennas for use will be selected automatically. During the auto-selecting of the antennas, the MCU 16 can ignore all input from the external button 19 by disabling the GPIO0. The MCU 16 can sequentially switch to the sets of external antennas 10a, 10b and internal antennas 12a, 12b in a predetermined period of time, to calculate the internal RSSI and the external RSSI. The MCU 16 then compares the internal RSSI and the external RSSI to determine the higher value thereof, and switch to the antenna set with the higher RSSI by controlling the RF switches 18a and 18b through the selection signal Sₛₑₗ. For example, when the external RSSI exceeds the internal RSSI, the MCU 16 can switch to the set of external antennas 10a, 10b by the selection signal Sₛₑₗ. When the external RSSI is less than the internal RSSI, the MCU 16 can switch to the set of internal antennas 12a, 12b by the selection signal Sₛₑₗ. When the external RSSI is substantially the same as the internal RSSI, the MCU 16 can maintain the previous selection of antenna set. If the IAD 1 is just powered on and no previous selection of antenna set exists, the MCU 16 can switch to a predetermined antenna set for startup, such as the set of external antennas 10a, 10b, or select at random from one of the sets of external antennas 10a, 10b and internal antennas 12a, 12b for the receiving antenna set.

In some embodiments, the MCU 16 determines one of the internal RSSI and external RSSI is higher than the other one only when one continuously exceeds the other one over a predetermined period of time. In other embodiments, the MCU 16 can first switch to one of the antenna sets, average the RSSI values over a predetermined period for the switched antenna set to obtain an average first RSSI, then switch to the other antenna set, average the RSSI values over the same predetermined period for the switched antenna set to obtain an average second RSSI, determine which of the average first or second RSSIs is higher, and lastly, determine the RSSI corresponding to the higher average RSSI as the higher RSSI between first and second RSSIs.

The MCU 16 can determine whether a disconnection condition has occurred based on the received signal S_{RSSI}. In some embodiments, after switching to one of the antenna sets, the MCU 16 can evaluate whether the signal S_{RSSI} of the received signal by the antenna set is less than a threshold RSSI. Upon detecting the condition of the received signal SRSSI being less than the threshold RSSI, the MCU 16 can evaluate whether the received signal SRSSI is less than the threshold RSSI for a first predetermined time length, e.g., 1 second. When the condition remains for a period exceeding the first predetermined time length, the MCU will determine a disconnection condition has occurred and it is required to switch to another antenna set to continue receiving the RF signal.

After the IAD 1 completes the above automatic antenna selection procedure, the MCU 16 can receive input from the external button by enabling the port GPIO0. The user can switch between the set of internal antennas 12a, 12b and the set of external antennas 10a, 10b in turn. For example, when the IAD 1 is receiving the RF signal via the set of internal antennas 12a, 12b, the user can press the external button 19 to generate a switch signal S_{sw} to the MCU 16. In response to the switch signal S_{sw}, the MCU 16 can generate the selection signal Sₛₑₗ to switch the receiving antenna set from the set of internal antennas 12a, 12b to the set of external antennas 10a, 10b. When the user once again presses the external button 19, another switch signal S_{sw} will be generated to the MCU 16. In turn, the MCU 16 can switch the receiving antenna set from the set of external antennas 10a, 10b to the set of internal antennas 12a, 12b. The user can select a preferred antenna set to communicate with the service network after switching back and forth between the antenna sets.

The IAD 1 may further include an indication light (not shown) indicating the present antenna set in use. For example, when the IAD 1 is using the set of external antennas 10a, 10b the indication light will be lit, and when the IAD 1 is using the set of internal antennas 12a, 12b the indication light will be out.

Although the IAD 1 is used in the LTE communication network, those skilled in the art would recognize that the IAD 1 may be adopted to meet the protocol specification for the third generation (3G), the fourth generation (4G), or a mobile communication network later than 4G. Further, the MCU 16 may utilize other types of signal qualities, such as the Signal to Noise Ratio (SNR), Reference Signal Received Power (RSRP), Channel Quality Indicator (CQI) or other types of signal quality indicators, to select an antenna set with a higher signal quality to communicate with the service network. Moreover, although each antenna set only has 2 antennas in the embodiment, those skilled in the art will know that each antenna set may include more than 2 antennas, as the LTE circuit 14 can receive and perform calculations based on more than 2 RF signals received by more than 2 antennas to obtain the corresponding signal quality.

The IAD 1 can automatically select a receiving antenna set based on signal quality, providing an accurate and automatic antenna selection function, and reducing the cost by utilizing RF switches.

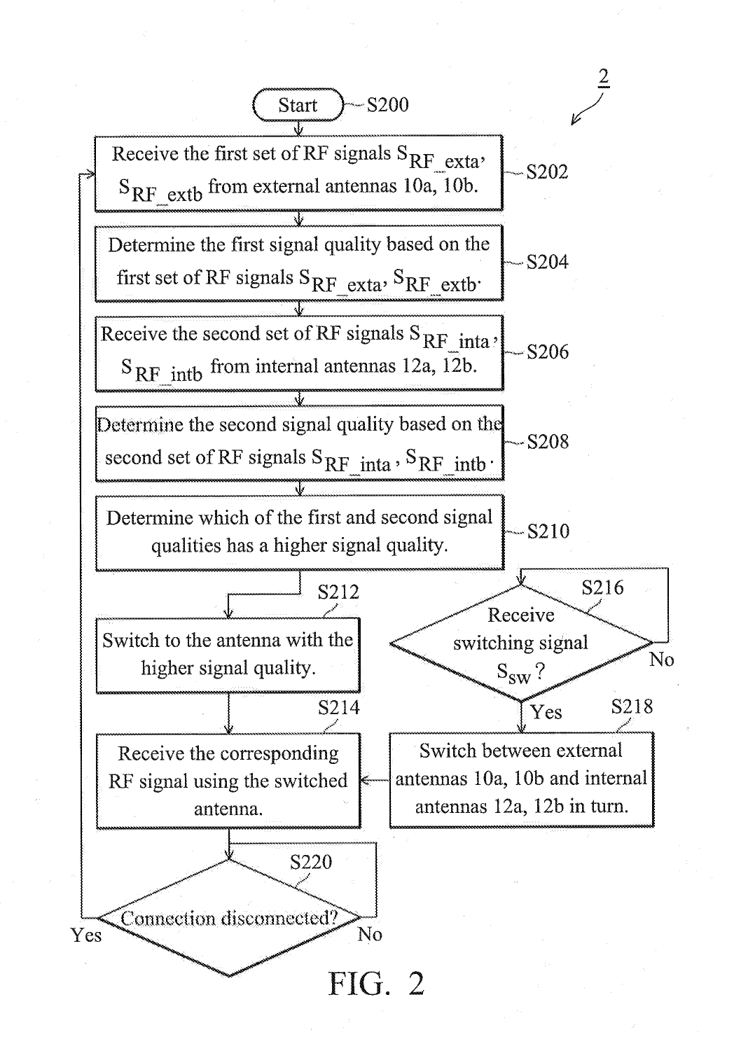

FIG. 2 is a flowchart of a control method according to an embodiment of the invention, incorporating the IAD 1 in FIG. 1.

Upon startup of the control method 2, the IAD 1 is powered on, the MCU 16 controls the port GPIO0 in a disabled state and the ports GPIO1 and USB in an enabled state, ready for receiving the RF signal from the air interface and automatically initiating the antenna set selection (S200). Next, the MCU 16 can switch to the external antennas 10a, 10b by the selection signal Sₛₑₗ, receive the first RF signals S_{RF}_{_{—}}ₑₓₜₐ, S_{RF}_{_{—}}_{extb} by the external antennas 10a, 10b and send the first RF signals S_{RF}_{_{—}}ₑₓₜₐ, S_{RF}_{_{—}}_{extb} to the LTE circuit 14 (S202). The LTE circuit 14 can determine the first signal quality according to the first RF signals S_{RF}_{_{—}}ₑₓₜₐ, S_{RF}_{_{—}}_{extb} and deliver the first signal quality to the MCU 16 (S204). Then, the MCU 16 can switch to the internal antennas 12a, 12b by the selection signal Sₛₑₗ, and send the second RF signals S_{RF}_{_{—}}ᵢₙₜₐ, S_{RF}_{_{—}}_{intb} to the LTE circuit 14 (S206). The LTE circuit 14 can determine the second signal quality according to the second RF signals S_{RF}_{_{—}}ᵢₙₜₐ, S_{RF}_{_{—}}_{intb} and deliver the second signal quality to the MCU 16 (S208). The signal quality may be indicated as RSSI, RSRP, SNR, CQI or another type of signal-quality indicator.

At this point, the MCU 16 has already acquired the information on the first and second signal qualities, thus it can compare the first and second signal qualities to determine which one has a higher signal quality (S210). For example, when the external RSSI exceeds the Internal RSSI, the MCU 16 can switch to the set of external antennas 10a, 10b by the selection signal Sₛₑₗ. When the external RSSI is less than the internal RSSI, the MCU 16 can switch to the set of internal antennas 12a, 12b by the selection signal Sₛₑₗ. When the external RSSI is substantially the same as the internal RSSI, the MCU 16 can maintain the previous selection of the antenna set. If the IAD 1 is just powered on and no previous selection of antenna set exists, the MCU 16 can switch to a predetermined antenna set for startup such as the set of external antennas 10a, 10b, or select at random from one of the sets of external antennas 10a, 10b and internal antennas 12a, 12b for the receiving antenna set. The MCU 16 can switch to the antenna set corresponding to the higher signal quality by the selection signal Sₛₑₗ (S212), receive the RF signal via the switched antenna set (S214), thereby completing the procedure of the automatic antenna set selection.

After the procedure of the automatic antenna set selection is completed, the MCU 16 can configure the port GPIO0 to an enabled state, providing the user with enough flexibility to select the antenna set by user preference. When the port GPIO0 is in the enabled state, the MCU 16 can continuously detect weather the user enters an input signal S_{sw} (S216). If no user input signal S_{sw} is detected, the MCU 16 can continue detection. If a user input signal S_{sw} is detected, the MCU 16 can switch in turn between the external antennas 10a, 10b and internal antennas 12a, 12b (S218), and receive the RF signal with the switched antenna set (S214).

While monitoring the user input, the MCU 16 can also determine whether a disconnection condition happens (S220). If no disconnection condition occurs the MCU 16 will continue monitoring. If a disconnection condition has occurred, the MCU 16 will return to step S202 to reconfigure the port GPIO0 back to the disabled state, and reinitiate the automatic antenna set selection procedure from Steps S202 through S214. The MCU 16 can determine whether the disconnection condition has occurred based on the received signal quality. In some embodiments, after switching to one of the antenna sets, the MCU 16 can evaluate whether the signal quality received by the antenna set is less than a signal quality threshold. Upon detecting the condition that the received signal quality is less than the signal quality threshold, the MCU can further evaluate whether the condition persists for longer than the first predetermined time length, such as 1 second. The MCU can determine the disconnection has occurred when the detected condition has persisted for a period exceeding the first predetermined time length.

The control method 2 can automatically select a receiving antenna set based on the signal qualities, providing an accurate and automatic antenna selection function, and reducing the cost by utilizing the RF switches.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or a combination of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical, blocks, modules, and circuits described in connection with the aspects disclosed herein may be implemented within or performed by an integrated circuit (“IC”), an access terminal, or an access point. The IC may comprise a general-purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside the IC, or both. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as falling within the known and customary practice within the art to which the invention pertains.

What is claimed is:

1. A control method, adopted by a wireless communication device, comprising:
receiving a set of first Radio Frequency (RF) signals from a set of external antenna ports;
determining a first signal quality based on the set of first RF signals;
receiving a set of second RF signals from a set of internal antennas;
determining a second signal quality based on the set of second RF signals;
determining which of the first or second signal quality is the higher signal quality; and
switching to the set of antennas corresponding to the higher signal quality.

2. The control method of claim 1, further comprising:
receiving a switch signal from an external button; and
in response to the switch signal, switching between the set of external antennas and the set of internal antennas in turn.

3. The control method of claim 1, wherein the step of the determining which of the first or second signal quality is the higher signal quality comprises:
when the first or second signal quality continuously exceeds the other over a predetermined period of time, determining the one with the exceeding signal quality has the higher signal quality.

4. The control method of claim 1, wherein the step of determining which of the first or second signal quality is the higher signal quality comprises:
averaging the first signal qualities computed in a predetermined period of time to acquire an average first signal quality;
averaging the second signal qualities computed in a predetermined period of time to acquire an average second signal quality;
determining which of the average first or second signal quality is the higher signal quality; and
determining the average signal quality with the higher signal quality as the higher signal quality in the first or second signal qualities.

5. The control method of claim 1, wherein the step of the determining which of the first or second signal quality is the higher signal quality comprises:
when the signal received by the switched set of antennas is disconnected for a period exceeding a predetermined disconnection period, then determining which of the first or second signal quality is the higher signal quality.

6. The control method of claim 1, wherein the step of the receiving the sets of first and second RF signals are conducted in a sequential order.

7. The control method of claim 1, wherein each set of internal and external antennas comprises two antennas.

8. A wireless communication device, comprising:
a set of external antenna ports, configured to receive a set of first RF signals from a set of external antennas;
a set of external antennas, configured to receive a set of second RF signals from a set of internal antennas;
a communication circuit, coupled to the set of external antenna ports and the set of external antennas, configured to determine a first signal quality based on the set of first RF signals and determine a second signal quality based on the set of second RF signals; and
a controller, coupled to the communication circuit, configured to determine which of the first or second signal quality is the higher signal quality, and switch to the set of antennas corresponding to the higher signal quality.

9. The wireless communication device method of claim 8, further comprising:
an external button, coupled to the controller, configured to receive a switch signal;
wherein in response to the switch signal, the controller is configured to switch between the set of external antennas and the set of internal antennas in turn.

10. The wireless communication device method of claim 8, wherein when the first or second signal quality continuously exceeds the other over a predetermined period of time, the controller is configured to determine the one with the exceeding signal quality has the higher signal quality.

11. The wireless communication device method of claim 8, wherein the controller is configured to:
average the first signal qualities computed in a predetermined period of time to acquire an average first signal quality;
average the second signal qualities computed in a predetermined period of time to acquire an average second signal quality;
determine which of the average first or second signal quality is the higher signal quality; and
determine the average signal quality with the higher signal quality as the higher signal quality in the first or second signal qualities.

12. The wireless communication device method of claim 8, wherein when the signal received by the switched set of antennas is disconnected for a period exceeding a predetermined disconnection period, the controller is configured to determine which of the first or second signal quality is the higher signal quality.

13. The wireless communication device method of claim 8, wherein the controller is configured to receive the sets of first and second RF signals conducted in a sequential order.

14. The wireless communication device method of claim 8, wherein each set of internal and external antennas comprises two antennas.
